(19) United States
(12) Patent Application Publication
(10) Pub. No.: US 2013/0013209 A1
(43) Pub. Date: Jan. 10, 2013

(54) PREDICTING ANISOTROPIC SOURCE ROCK PROPERTIES FROM WELL DATA

(76) Inventors: Yaping Zhu, Katy, TX (US); Shiyu Xu, Kingwood, TX (US); Enru Liu, Sugar Land, TX (US); Michael A. Payne, Spring, TX (US); Martin J. Terrell, Spring, TX (US)

(21) Appl. No.: 13/521,948

(22) PCT Filed: Jan. 31, 2011
(86) PCT No.: PCT/US11/23204

§ 371 Date: Jul. 12, 2012

Related U.S. Application Data
(60) Provisional application No. 61/312,907, filed on Mar. 11, 2010.

(51) Int. Cl. G01V 3/18; G06F 19/00

(52) U.S. Cl. 702/6

(57) ABSTRACT

Method for predicting physical properties of a source rock formation wherein an inclusion-based (103) mathematical rock physics model (101) is constructed that treats organic matter as solid inclusions, solid background, or both, and relates anisotropic elastic and electric properties of source rock to in-situ rock and fluid properties (102). The model is calibrated with well log data and may be used to forward model calculate effective anisotropic elastic (104.1) and electrical (104.2) properties of the source rock formation, or by inversion (441-442) of sonic and resistivity log data to calculate total organic carbon (423) in terms of a difference (421) between elastic and electrical properties of the source rock.

### CROSS-REFERENCE TO RELATED APPLICATION

This application claims the benefit of U.S. Provisional Patent Application 61/312,907, filed Mar. 11, 2010, entitled Predicting Anisotropic Source Rock Properties from Well Data, the entirety of which is incorporated by reference herein.

### FIELD OF THE INVENTION

This invention relates generally to the field of geophysical prospecting, and more particularly to determining rock properties of source rocks. More specifically, it relates to forward rock physics modeling to estimate effective rock properties (elastic and electrical) from mineralogical compositions such as total organic carbon (“TOC”), and inversion to estimate TOC from the effective rock properties. The effective rock properties are useful for calculating (simulating) geophysical responses of a source rock formation, which in turn is useful for a variety of techniques associated with potential development of the source rock formation, whereas TOC is an indication of hydrocarbon potential.

### BACKGROUND OF THE INVENTION

Unconventional resources such as shale gas are becoming increasingly important exploration and production targets. While much of US natural gas production comes from conventional resources, recent growth is dominantly from some unconventional resources such as shale gas and tight gas. Shale gas is natural gas produced from shale, usually in organic-rich shale. Economic shale gas development candidates typically require ample organic matter to generate sufficient volumes of hydrocarbons, i.e., relatively high TOC (total organic carbon). Depending on different geologic settings, the formations can be highly heterogeneous and their micro-scale structures can be very complicated.

Over the last several decades, rock physicists have developed a range of techniques to estimate rock and fluid properties in shale and other clastic silicate rocks (e.g., Hornby et al., 1994; Sayers, 2005; Drxge et al., 2006). However, these approaches of shale rock physics often do not include the organic matter that can be an important component in shale gas formations.

The term source rock refers to the organic-rich rock from which hydrocarbons have been generated or are capable of being generated. They are typically fine-grained rocks with grain sizes less than 0.0625 mm, which includes gas shale and oil shale. Because in these rocks, source, reservoir, and seal can share many characteristics, a rock physics relationship applicable to source rock can also be applied to reservoir and seal rocks.

Rock properties that will be model parameters when a forward modeling process is pursued include elastic and/or electrical properties (e.g., P- and S-wave velocities, anisotropy, and resistivities), and when an inversion process is pursued the rock properties of interest are properties of organic matter content of the rocks (e.g., TOC).

Since organic matter is usually a very soft, but resistive material, it affects the elastic and electrical properties of a source rock differently. Δ Log R (Passey et al., 1990) is a formation evaluation method to estimate TOC from sonic and resistivity logs and has been widely used in the oil and gas industry. In this method, appropriately scaled sonic and resistivity logs are overlain to establish a baseline for non-source rocks and the deviation between the pair of logs is indicative of TOC. However, the method is empirical, relying on practitioner's experience to identify the non-source rocks before evaluating TOC. It assumes that organic matter is the only component that causes a source rock to differ from a non-source rock. In other words, for each selected baseline, it assumes that the source and non-source rocks have the same mineralogy components, pore structures and fluid content. Moreover, it does not handle anisotropy, which can be substantial for source rocks. Δ Log R has been recently extended to substitute remotely obtained seismic and controlled-source electromagnetic data for the well log data. (PCT Application No. PCT/US2010/05312).

To further improve the TOC estimation method, it was perceived that a rock physics model was needed to handle the combined effect of TOC, and other rock properties, e.g. mineralogy, fluid content, and pore structure. Hornby et al. (1994) proposed a rock physics model to determine elastic properties of non-source rocks. This method is based on a combination of the self-consistent and differential effective-medium theories to predict elastic properties of the composite solid. However, the Hornby method is limited to pure shales and is not applicable to sandy shales or shaly sands, which have often been observed in source rock formations. Their method does not handle organic matter and is not applicable to source rocks. Moreover, it does not handle electrical properties, which are critical for estimating water saturation and depend on the maturity of source rocks. For example, as organic matter begins to mature, hydrocarbons are expelled from the kerogen and displace part of formation water in nearby pores (or possibly water-filled pores within the kerogen), which results in an increase in resistivity of the entire rock. Since TOC has different effects on elastic and electrical properties of source rocks, the estimate of TOC using elastic and electrical properties is more reliable than using elastic properties only.

Bayuk et al. (2008) discuss a physical model of shale that contains kerogen as a common type of organic matter. In their method, kerogen is assumed to form a network surrounding the clay particles, which implies that TOC of the source rock has to be high enough to make this model applicable. This method uses the kerogen amount (i.e., volume of organic matter, or corresponding to TOC) as an input parameter. However, it does not handle the microstructure (aspect ratio and alignment) of organic matter, which can have significant effects on elastic and electrical properties, especially anisotropy of both velocity and resistivity. Moreover, it does not handle electrical properties.

Since organic matter is typically a solid not a fluid, the traditional Gassmann fluid substitution does not work. Ciz and Shapiro (2007) proposed a solid substitution method using the generalized Brown and Korring a equations (1975). While Ciz and Shapiro's method works well, it does not predict the electrical properties of the rock. Furthermore, it does not handle pore alignment that contributes to anisotropy. Vernik and Liu (1997) showed that anisotropy is an important feature of a source rock. Therefore, it is important to have a rock physics model simulate the effects of TOC on anisotropy correctly.

As a general observation, the published literature on rock physics models for source rocks ignores the microstructure of inclusion space (including aspect ratio and alignments) filled with organic matter. These traditional rock physics models also generally ignore the electrical properties of source rocks. The present invention responds to these shortcomings

### SUMMARY OF THE INVENTION

The invention includes a method for predicting physical properties of a source rock formation, comprising: constructing an inclusion-based mathematical rock physics model that treats organic matter as solid inclusions, solid background, or both, and as a resistive phase of the source rock, and relates anisotropic elastic and electric properties of source rock to in-situ rock and fluid properties; and using the rock physics model either in a forward modeling sense to calculate effective anisotropic elastic and electrical properties of the source rock formation, or by inversion of sonic and resistivity logs to calculate total organic carbon in terms of a difference between elastic and electrical properties of the source rock. In all practical applications of the present inventive method both the construction of the inclusion-based mathematical rock physics model and the using of the rock physics model to calculate effective rock properties or TOC would be done using a computer programmed in accordance with the teachings herein.

Some forward modeling embodiments comprise constructing an inclusion-based mathematical rock physics model that treats organic matter as solid inclusions, or partly solid inclusions and partly solid background for calculating elastic properties, and as a resistive phase of the source rock for calculating electrical properties, and relates anisotropic elastic or electrical properties of source rock to in-situ rock and fluid properties; and using the rock physics model to calculate effective elastic properties or effective electrical properties of the source rock formation. The model may have a rock matrix consisting of solid background and inclusion space, where a partitioning parameter specifies organic matter distribution between the solid background and the inclusion space, and where the inclusion space is partitioned into fluid-filled pores and organic matter-filled inclusions.

In some inversion embodiments, the difference between elastic and electrical properties of the source rock is a difference between two model inversion estimates of volume concentration of fluids, one estimate obtained by inverting sonic log data and the other obtained by inverting resistivity log data.

### BRIEF DESCRIPTION OF THE DRAWINGS

The present invention and its advantages will be better understood by referring to the following detailed description and the attached drawings in which:

FIGS. 1A-D are schematic views of the model partitioning of the present invention, for non-source rock (1A) and source rock (1B-D);

FIG. 2 is a flowchart showing basic steps in a forward rock-physics modeling embodiment of the present invention, generating effective elastic and electrical properties of source rocks;

FIG. 3 is a flow chart showing more detailed steps for how effective elastic properties are calculated in one embodiment of the invention;

FIG. 4 is a flow chart showing more detailed steps for how effective electrical properties are calculated in one embodiment of the invention;

FIG. 5 is a flow chart showing basic steps in an inversion embodiment of the present invention, generating an estimate of the volume of organic matter (or TOC) from sonic and resistivity properties, with the chart divided into two parts (A and B) because of length;

FIG. 6 shows test results for a shale gas formation using a forward modeling embodiment of the invention;

FIG. 7 illustrates a test application of an inversion embodiment of the present invention to estimate TOC from sonic and resistivity logs;

FIGS. 8A-B illustrate an inventive method for estimating volume concentrations of organic matter and fluid from fluid volume concentrations inverted from elastic properties and from electrical properties;

FIG. 9 is a schematic view of a deviated well (thick solid curve) penetrating shale rock (parallel lines) that is characterized as an effectively anisotropic medium with its symmetry direction denoted with the dashed line; and

FIG. 10 illustrates the “true” model compared to an effective model with initial guess of V₀^{org}, used to represent the true model in TOC inversion embodiments of the present invention.

The invention will be described in connection with example embodiments. However, to the extent that the following description is specific to a particular embodiment or a particular use of the invention, this is intended to be illustrative only, and is not to be construed as limiting the scope of the invention. On the contrary, it is intended to cover all alternatives, modifications and equivalents that may be included within the scope of the invention, as defined by the appended claims.

### DETAILED DESCRIPTION OF EXAMPLE EMBODIMENTS

The present inventive method is built on a rock physics relationship, or mathematical model, that handles the effects of organic matter on the elastic and electrical properties of source rocks. The model can be used in both forward modeling and backward calculation (inversion) of rock properties. The inventive rock physics relationship for source rocks is constructed by partitioning organic matter-filled volumes into the solid background and the inclusion space. The relationship is calibrated, preferably by well log data, to determine some of the model parameters. The calibrated rock physics relationship may then be used to estimate rock properties. In the forward modeling embodiments, input parameters of the rock physics model include, but are not limited to, shale volume, porosity, fluid content (or water saturation), and volume of organic matter (or equivalently TOC, which usually refers to the weight percentage of organic matter). The output parameters include, but are not limited to, density, P- and S-wave velocities, resistivity, velocity anisotropy, and resistivity anisotropy. In the inversion embodiments, input parameters may include, but are not limited to, shale volume, water saturation, density, sonic, and resistivity logs. The output parameters may include volume of organic matter (or TOC) and/or porosity.

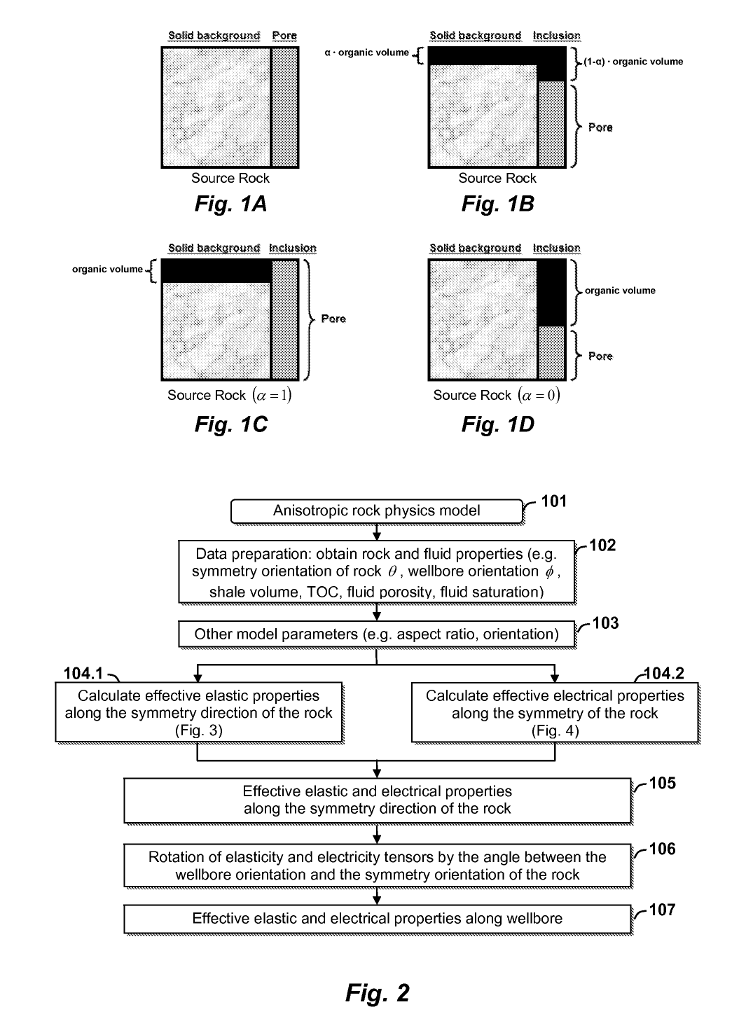

The rock physics model of the present invention is a microscopic scale model, describing the rock at the inclusion, or pore, level. (The term “inclusion space” is generally used herein instead of “pore space” because the latter is sometimes considered limited to containing fluids, whereas the intent herein is that the space may be filled by fluids or solids.) The model must describe at this level, i.e. be inclusion based, in order to get to the properties that affect both elastic and electrical behavior. For example, pore aspect ratio and pore orientation distribution both affect anisotropy, whether elastic or electrical. The model's parameters may include symmetry orientation of the rock which may be defined by a dip angle θᵣ and azimuthal direction ψᵣ, wellbore orientation defined by the deviation (from vertical) angle φ_{w} and azimuthal direction ψ_{w}, shale volume, TOC, volume concentrations of other constituents (e.g., quartz, calcite, etc.), fluid porosity, fluid saturation, aspect ratios and orientations of different constituents, other physical properties (e.g., density, bulk and shear moduli, conductivity, etc.) of different constituents, temperature, and salinity. A feature of the model is that can treats organic matter as solid inclusions, solid background, or both. (See FIGS. 1B-D) Whether used in forward modeling embodiments or in inversion embodiments, the model of the present invention can be either a unified model that relates elastic and electrical parameters to in-situ rock and fluid properties, or it can be two separate models with common physical parameters being consistent, one model relating elastic properties to in-situ rock and fluid properties and the other relating electrical properties to in-situ rock and fluid properties, and the model shall be understood this way throughout the application including the claims. For convenience, however, the model is usually described herein and shown in the drawings as a single, unified model.

The present inventive method builds on an integrated anisotropic rock physics model (Xu et al., 2008), where the pore space can be grouped into different types. For clastic rocks, effective rock properties can be calculated by dividing the pore space into (1) clay-related pores, (2) sand-related pores, and (3) microcracks (mainly in the sand component) and doing fluid substitution for the pore space. Hence, the anisotropic rock physics model for non-source rocks (i.e., without organic matter) is already discussed by Xu et al. (2008). Since organic matter in source rocks is a solid material instead of fluid, the invented approach is an alteration of the base approach by handling organic matter in source rocks. Also, the model of Xu, et al. applies to elastic properties only, and not to electrical properties.

Thus, an object of the invention is to build (1) a forward physics modeling method that establishes an appropriate rock physics relationship that handles effects of organic matter in addition to other mineral and fluid effects in source rocks, and (2) an inversion method, based on the difference between elastic and electrical properties, for applying the results of the forward physics modeling workflow to characterize source and reservoir properties including TOC.

### Forward Modeling Embodiments—Theoretical Formulation

The effective rock properties can be characterized with the following two generic forms:

S_{V}^{eff}=ƒ_{V}(V^{org},V^{ƒ};other parameters), (1)

S_{R}^{eff}=ƒ_{R}(V^{org},V^{ƒ}; other parameters), (2)

where S_{V}^{eff} is an effective elasticity tensor from which other elastic properties such as P-wave velocity and anisotropy can be derived, and S_{R}^{eff} is an effective electricity tensor from which other electrical properties such as horizontal resistivity and resistivity anisotropy can be derived. Subscripts “V” and “R” denote the elastic and electrical properties, respectively. Function ƒ describes a rock physics model that handles the effects of organic matter and fluids, and V^{org} and V^{ƒ} are the volume concentrations of organic matter and fluids, respectively.

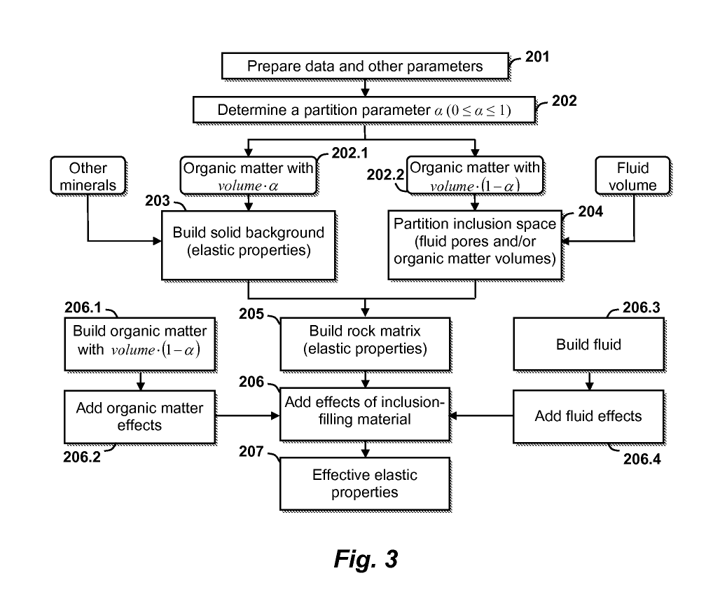

Following the work by Xu et al. (2008), a new rock physics model to calculate anisotropic elastic and electrical properties of organic-rich rocks will now be described. First, the “dry” rock frame is constructed by adding (1) empty inclusions associated with relatively large pores and organic matter, and (2) water-wet micro-pores (such as clay pores) into the system using an effective medium theory. The “dry” rock frame is not really dry since it may contain a certain amount of water depending on parameters such as clay content. For inclusions occupied by pore fluid, the standard anisotropic Gassmann fluid substitution (Brown and Korring a, 1975) is performed. For inclusions occupied by organic matter, the solid substitution as described by Ciz and Shapiro (2007) is performed; this is a generalized version of Brown and Korring a's equation 32 and is given by

$${S}_{ijkl}^{eff} = {S}_{ijkl}^{dry} - \frac{( {S}_{ijmn}^{dry} - {S}_{ijmn}^{g r} ) ( {S}_{klpq}^{dry} - {S}_{klpq}^{g r} )}{{[ {V}^{org} ( {S}^{org} - {S}^{V} ) + ( {S}^{dry} - {S}^{g r} ) ]}_{mnpq}} , \qquad ( 3 )$$

where V^{org} is the volume concentration of the inclusion space that is filled with organic matter, which is normalized by the total volume of the rocks. Sᵢⱼₖₗ^{gr},Sᵢⱼₖₗ^{dry}, and Sᵢⱼₖₗ^{eff} are fourth-rank compliance tensors of the grain mineral, the rock matrix (frame) with empty inclusion space plus some water-wet micro-pores, and the overall rock sample, respectively. S^{V} and S^{org} are, respectively, the compliance tensor of the inclusion space of the rock frame and that of the organic matter. Indices and q are permuted from 1 to 3. Here, the calculation of the compliance tensor of the rock matrix applies to step 205 of FIG. 3. Since S^{org} fully describes the elastic behavior of the pore-filling material (organic matter in this case), Equation (3) handles solid substitution with non-zero shear modulus. If the inclusion-filling material is fluids, Equation (3) reduces to the case of the fluid substitution. Finally, Equation (3) applies to any type of anisotropy.

It may be noted that the solid substitution method of Ciz and Shapiro does not cover electrical properties of the source rocks, while the present inventive method is capable of predicting both elastic and electrical properties. In the inventive method, the solid substitution is included as one intermediate step in the forward modeling and inversion workflow of elastic properties (but not electrical properties).

Modeling the effective electrical properties of the rock is more straightforward because it does not have the complication of pore fluid relaxation. The same process is used to break the rock into different constituents. Willis's (1977) formula (his Equation (3.16)) is then applied to calculate the electrical properties of the rock. Here the effective property tensor L is given by

$$L = {\sum }_{r = 1}^{n} {c}_{r} {{L}_{r} [ I + {P}_{0} ( {L}_{r} - {L}_{0} ) ]}^{- 1} {\{ {\sum }_{s = 1}^{n} {{c}_{s} [ I + {P}_{0} ( {L}_{s} - {L}_{0} ) ]}^{- 1} \}}^{- 1} , \qquad ( 4 )$$

where I is the unit tensor, L₀ is the property tensor of a hypothetical reference medium having vanishing volume, and P₀ is a tensor that is a function of pore geometry and the properties of the reference medium. Depending on the choice of the reference medium, the predicted effective material property varies between the generalized Hashin-Strikman bounds. For example, if the most conductive phase is chosen as the reference medium, one gets the upper bound for the effective conductivity whereas; if the least conductive phase is chosen, one gets the lower bound. The contribution of the r-th phase, whether it be a grain particle or pore fluid, is expressed through the volume fraction and property tensor for such a phase, as well as its geometry (e.g., the aspect ratio for a pore) that is related to the tensor P₀. For a rock sample with an isotropic background percolated with one type of spheroidal inclusions that are isotropic and perfectly aligned, Willis also provided the analytical expression for P₀ and the effective conductivity tensor is characterized with VTI symmetry (transverse isotropy with vertical symmetry).

To account for many practical cases where constituents such as clay, pores and organic matter-filled inclusions can be partially aligned, a rotation process such as the one disclosed by Xu and White (1998) may be adopted to calculate the effects of various constituents on overall rock properties. In addition, the Waxman and Smits equation (1968) may be incorporated into the model to simulate the effect of clay on the overall electrical properties of shaly sand (Xu and White, 1998).

### Partitioning of Organic Matter

FIGS. 1A-D describe a schematic view of the partitioning for non-source (1A) and source rocks (1B-D). For non-source rock, where organic matter is absent, the rock sample is partitioned into the solid background and pore space. (Partitioning is discussed in more detail in the description of the flow chart FIG. 3.) For source rocks, the rock sample is composed of the solid background and inclusions, where both can contain the organic matter. A partitioning parameter α(0≦α≦1) may then be defined for determining the volumes of organic matter considered as part of the solid part and the inclusion part. FIG. 1C corresponds to the case when all organic matter is considered as part of the solid background (i.e., α=1), and FIG. 1D corresponds to the case when all organic matter is considered as part of the inclusion space (i.e., α=0). FIG. 1B depicts the case where α is between zero and unity, i.e. where the organic matter is distributed partly in the inclusion space and partly in the solid background. Using such a partitioning parameter, the model can describe any situation within the range (0≦α≦1), or within any lesser subset of that range.

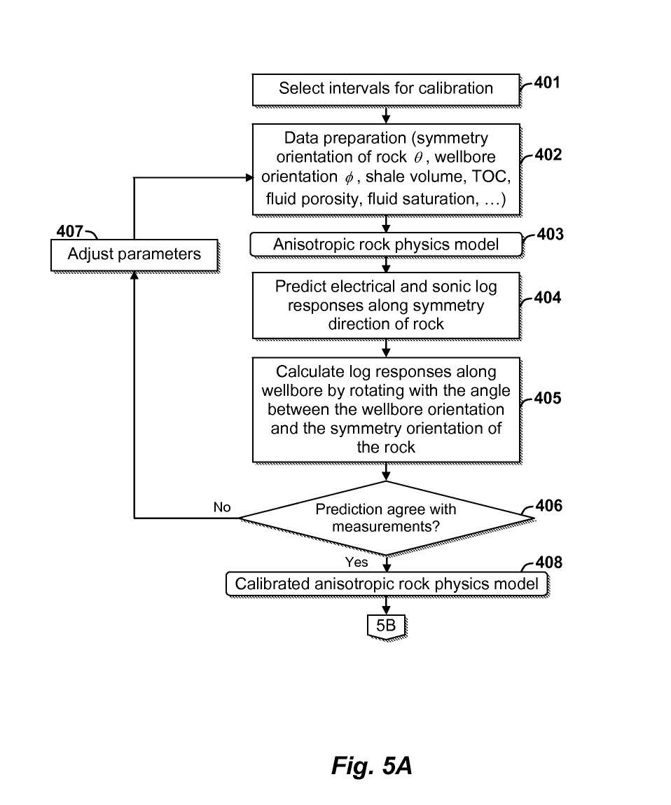

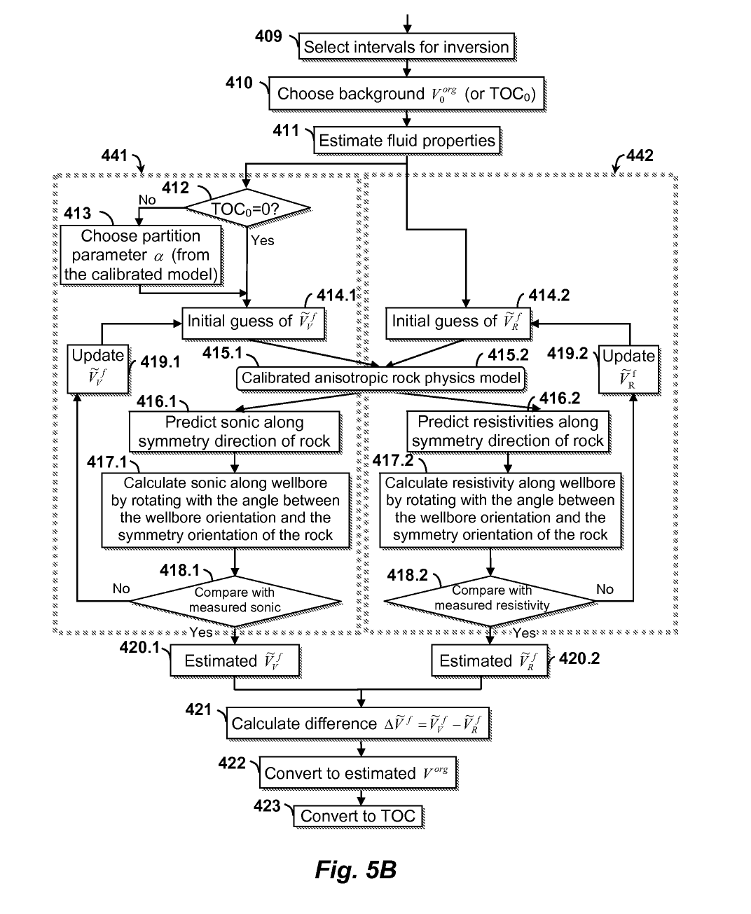

Determining the partitioning parameter can be based on experience, available information, or among other techniques, it can be determined by an inversion process where α is treated as an unknown parameter. For example, if core data, such as the mineral composition and TOC, microstructure (including spatial distribution) of clays, pores and organic matter, and measurements of elasticity and electricity of the core samples, are available, the partitioning parameter can be inverted from minimizing the difference (or mismatch) between the predicted elastic and electrical properties of the rock and the measurements. Thus, α can be treated as an extra unknown in an inversion embodiment of the invention such as is illustrated in FIG. 5. Otherwise, it may be noted that α depends on the properties of organic matter under the reservoir conditions, such as bulk and shear moduli and microstructure. For example, if organic matter is relatively hard and is load-bearing material, it may be reasonable to treat such organic matter as part of the solid background, similar to that of clay. Conversely, if organic matter is relatively soft under the reservoir conditions and interconnected, it may be reasonable to assume that the stress state in the organic matter-filled inclusion space is uniform and hence, organic matter can be treated as part of the inclusion space. In many cases, satisfactory results have been obtained by treating organic matter as part of the inclusion space, which is consistent with results from other methods such as Δ Log R. In other cases, the rock properties are predicted reasonably well by partitioning organic mater into the solid background as well as the inclusion space.

The inclusion space in the model is further partitioned into the space occupied by organic matter and that by different types of fluids. For inclusion space filled with fluids, Gassmann's (or Brown and Korring a's) equations (Brown and Korring a [1975]: Eqn. 32) can be used for the fluid substitution. For inclusion space filled with organic matter, the solid substitution by Ciz and Shapiro (2007) can be used. For electrical properties, the contribution of different phases in the inclusion space can be calculated from Willis's (1977) equation (Eqn. 3.16 in the Willis paper).

The further partitioning of the fluid-related pores has been discussed by Xu et al. (2008), and Patent Application Publication Number US/2008/0086287 is incorporated by reference herein in its entirety in those jurisdictions that allow it.

Basic steps of the forward rock physics embodiments of the invention are described next, with reference to the flow chart of FIG. 2.

In step 101, a mathematical form of an anisotropic rock physics model is chosen; see the previous description of suitable models. This must be a pore-level, i.e., inclusion-based description of source rock, and it must treat source rocks where the organic content can be solid background (i.e., α=1), solid inclusions (i.e., α=0), or both (i.e., 0<α<1). Also, it must relate anisotropic elastic and electric properties of source rock to in-situ rock and fluid properties. Such a model is described herein.

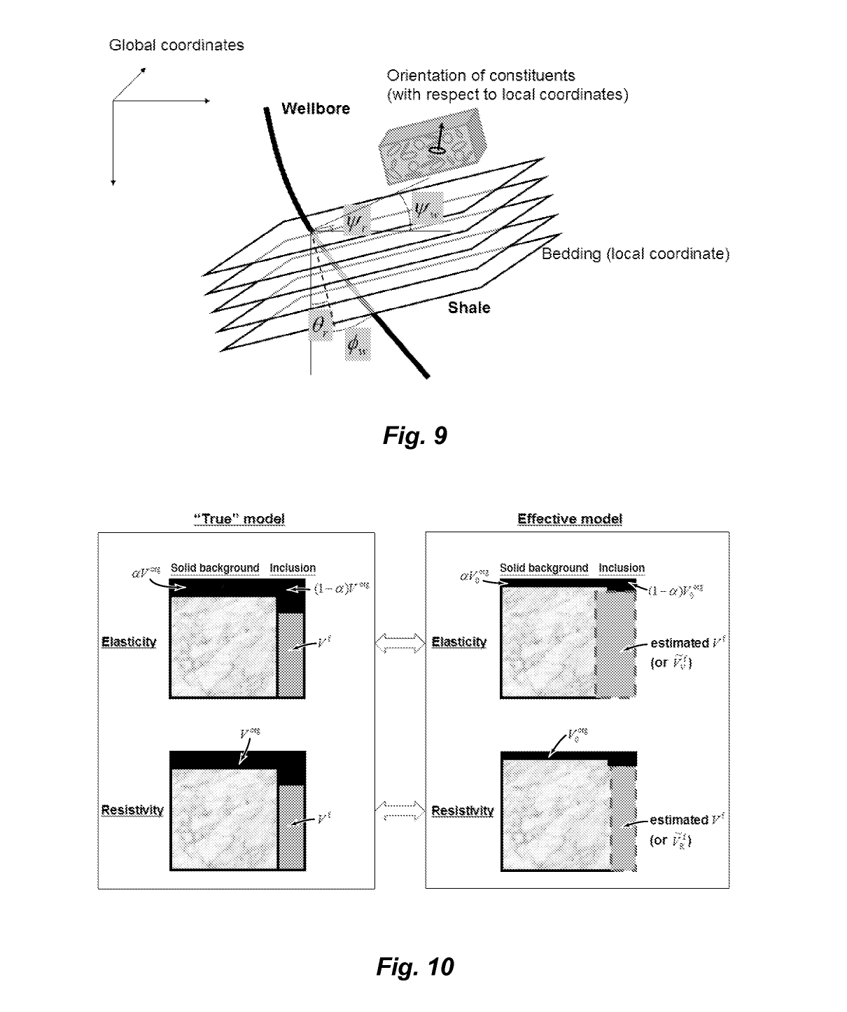

In step 102, rock and fluid properties representative of the source rock formation are obtained, e.g., shale volume fraction, porosity, water saturation, and fluid salinity, which can be obtained from well logs such as gamma ray, density, neutron porosity, sonic, and resistivity logs, or by core analyses. Environmental parameters such as temperature and pressure can be determined from downhole measurements. The symmetry orientation of the rock, defined with the dip angle θᵣ and azimuthal direction ψᵣ and the wellbore orientation, defined with the deviation (from vertical) angle φ_{w} and azimuthal direction ψ_{w}, are also determined See FIG. 9. The dip and azimuth angles of the rock can be estimated from, e.g., image logs or seismic data. The deviation and azimuth angles of the wellbore can be obtained from the drilling.

In step 103, other input parameters (including description of the microstructure such as the aspect ratios and alignments of different constituents) of the rock physics modeling process are determined by any available method. Orientations of all different constituents refer to local coordinates characterized by the symmetry direction and the bedding plane of the rock (see FIG. 9). The purpose of steps 102 and 103 is to determine all parameters in the model except the one or more that one wishes to solve for.

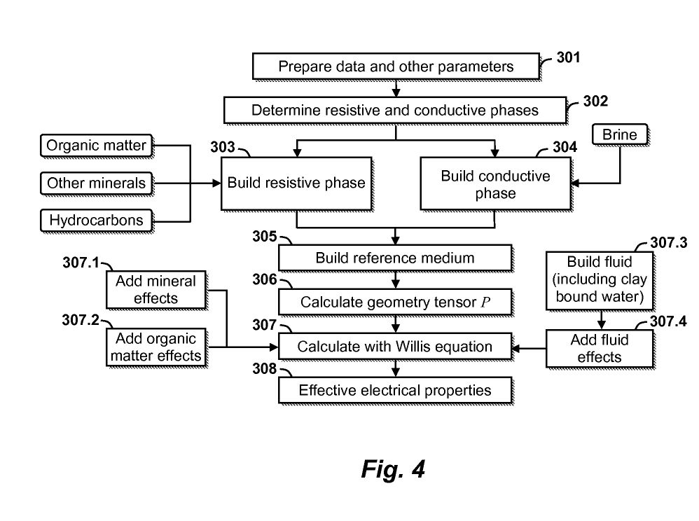

In steps 104.1-2, elastic (104.1) and electrical (104.2) properties are calculated from the model, or from parameters that are found directly by forward modeling using the model from steps 101-103. The calculated effective elastic and electrical properties refer to those along the symmetry orientation of the rock, and similarly in step 105. The flow charts of FIGS. 3 and 4 explain steps 104.1 and 104.2, respectively, in more detail for certain illustrative embodiments of the invention. All calculations for deviated wells are carried out on local coordinates characterized by the symmetry direction and the bedding plane of the rock. The results at step 105 are effective elastic and electrical properties of the source rock formation.

In step 106, effective elasticity and electricity tensors are rotated by the angle between the wellbore orientation and the symmetry orientation of the rock (which can be expressed as φ−θ if the wellbore orientation and the symmetry orientation of the rock have the same azimuth), which results (107) in effective elastic and electrical properties along the wellbore. Effective velocity anisotropy is considered as having TI (transverse isotropy) symmetry in some embodiments of the model and can be obtained using Equations (10a-c) in Thomsen (1986). Effective resistivity anisotropy is also considered as having TI symmetry in some embodiments of the model and may be represented through the ratio of resistivity component along the symmetry direction of the rock and that perpendicular to it (i.e., parallel to the bedding plane).

### Forward Modeling of Elastic Properties

Modeling elastic properties is described next with reference to FIG. 3. In step 201, those model parameters and rock properties needed to model elastic properties are obtained or determined. (This is covered in FIG. 2, steps 102 and 103, but is also included here for completeness.)

In step 202, the user determines whether organic matter forms part of the solid background or the inclusion space of the rock (or part of each), using the partition parameter α(0≦α≦1) described above or something equivalent. In step 202.1, a part of the organic matter, defined by the volume concentration of organic matter multiplied by α, is assigned to the solid background. In step 202.2, the remainder of the organic matter, defined by the volume concentration of organic matter multiplied by (1−α), is assigned to the inclusion space.

In step 203, elastic properties of the solid background are calculated using mineral particles comprising the rock, which depends on the outcome of step 202.1. If organic matter is considered to make up part of the solid background (i.e., α>0), mix organic matter with other minerals (e.g., quartz, calcite, and clay particles). Otherwise, mix other minerals without organic matter.

In step 204, the inclusion space is partitioned, which depends on the outcome of step 202.2. If all organic matter is considered as part of the solid background (i.e., α=1), inclusion space is then comprised of fluid-filled pores only. Otherwise, part of organic matter is considered as within the inclusion space, and hence the inclusion space is partitioned into fluid-filled pores and organic matter-filled volumes.

In step 205, elastic properties of the rock matrix are calculated based on the results from steps 203 and 204. In step 206, effects of the inclusion-filling material are calculated, which depends on the outcome of step 202. If all organic matter is considered as part of the solid background (i.e., α=1), that means the inclusions (pores) will all be filled with fluids of one type or another. The fluid type(s) are determined in step 206.3, and elastic properties (e.g., bulk modulus) and microstructure descriptions (including aspect ratio and alignment) of mixed fluids for different pores are obtained. The fluid effects on elastic properties are then estimated in step 206.4 using fluid substitution. In the α=1 scenario, steps 206.1-2 do not come into play. For α<1, steps 206.3-4 apply to the pores not filled with organic matter, and the method goes to step 206.1, where elastic properties (e.g., bulk and shear moduli) and microstructure descriptions (including aspect ratio and alignment) are obtained for organic matter with partitioned volume concentration, i.e., volume concentration of organic matter multiplied by (1−α). Then, in step 206.2, the effects of organic matter are added to the rock matrix using solid substitution.

Adding the effects of inclusion-filling material to the properties of rock matrix results in obtaining effective elastic properties of the rock at step 207. Additional details and example ways of performing some of the steps in FIG. 3 follow next.

In step 201, fluid properties such as density and velocity (or bulk modulus) can be estimated as functions of water saturation, temperature, pressure, fluid salinity, among others. Elastic properties (such as density and bulk and shear moduli) of organic matter can be obtained from laboratory experiments of the material, or using properties of coals as an analog. Input parameters of pore structure such as pore size, aspect ratio, and alignment can be estimated from (for example) microscope photos, or high-resolution 3D CT scanning images, or nanoscale images such as from focused ion beam (FIB) milling of rock samples, if available. Input parameters of microstructure of organic matter can also be estimated from (for example) microscope photos or high-resolution 3D CT scanning images, or nanoscale images such as from focused ion beam (FIB) milling of rock samples, if available.

In step 203, properties of the solid background can be calculated using a mixing process such as Voigt-Reuss-Hill averaging.

To clarify step 204 (and 206), inclusion space is generally composed of both fluid-filled pores and organic matter-filled volumes. If all organic matter is considered as part of the solid background, the including space is composed of fluid-filled pores only. Therefore, fluid-filled pores are always part of the inclusion space, while organic matter-filled volumes may or may not be part of it, depending on the partitioning of the organic matter-filled volumes into the background and the inclusion space. The fluid-filled pores can include (1) clay-related pores, (2) sand-related pores [also including pores associated with other minerals (e.g., calcite or pyrite) that may present in the rocks], and (3) microcracks (mainly in the sand component [or other minerals (e.g., calcite or pyrite) that may present in the rocks]). Further partitioning of fluid-filled pores can be achieved using a process first disclosed by Patent Application Publication Number US/2008/0086287. In steps 202.1 and 202.2, the volume concentration of organic matter can be obtained from TOC data. It should be noted that in the forward modeling process, TOC data is assumed to be known information. However, TOC may be estimated by inversion, using the rock physics model of the present invention, as is disclosed below.

In step 205, the rock matrix or dry rock frame may be formed by embedding water-wet micro-pores (which is part of the inclusion space) and the rest of the inclusion space (which is considered empty) into the solid background using an effective medium theory such as the differential effective medium theory described by Hornby et al. (1994) or the anisotropic dry rock approximation discussed by Patent Application Publication Number US/2008/0086287. Since some inclusions in source rocks are partially aligned, orientations need to be taken into account in the calculation of the rock matrix using, for example, a rotation process disclosed by Xu and White (1998).

In step 206, fluid filled pores may be partitioned using the process described by Xu et al. (1998). Bound-water volume (clay pores) may be estimated from shale volume (Xu and White 1995). The rest of water will then be mixed with hydrocarbons, if any, using a mixing law such as the Wood Suspension model, in step 206.3. If part of the inclusion space is filled with a mixture of fluids and organic matter, the fluids and organic matter can either be treated separately, or the mixture may be considered as an effective infill material by using a mixing law. For the latter case, solid substitution may be applied to the effective infill material since it has non-zero shear modulus.

For elastic properties, substitution of solid material into the inclusion space (step 206.2) can be calculated using Equation (3). Substitution of fluid (step 206.4) can be implemented using Brown and Korringa's (1975 paper, Eqn. 32) equations. Fluid substitution (step 206.4) can also be implemented using Equation (3) provided that the shear modulus is set to zero. Also, it should be noted that when organic matter constitutes part of the inclusion-filling material, i.e., when steps 206.1-2 are performed, the order in which that pair of steps is performed compared to the parallel pair of operations 206.3-4 is obviously immaterial.

The calculated effective elastic properties (207) can be described using an elasticity tensor, or using parameters including P- and S-wave velocities, density, velocity anisotropy, or other properties derived from the aforementioned elastic parameters. The velocity anisotropy can be represented through Thomsen's anisotropic parameters ε, δ, γ (Thomsen, 1986).

### Forward Modeling of Electrical Properties

Modeling electrical properties is described next with reference to FIG. 4. In step 301, those model parameters and rock properties needed to model electrical properties are obtained or determined. (This is covered in FIG. 2, steps 102 and 103, but is also included here for completeness.)

In step 302, resistive and conductive phases in the rock are determined, where organic matter, various minerals, and hydrocarbons usually consist of the resistive phase, while brine usually consists of the conductive phase. In steps 303-304, electrical properties of the resistive and conductive phases are calculated using, for example, Voigt-Reuss-Hill averaging.

In step 305, electrical properties of the reference medium are calculated based on the results from steps 303 and 304 using, for example, Voigt-Reuss-Hill averaging. In step 306, the geometry tensor P₀ is calculated using, for example, formulae disclosed (Eqn. 5.10) by Willis (1977).

In step 307, the contributions from different constituents may be calculated using a Willis (1977) equation (Equation 3.16). In step 307.1, mineral effects of different minerals are added, including quartz grains and clay particles, or other minerals, if available. In step 307.2, the effects of organic matter are added to the model. In step 307.3, fluids are built including clay bound water, where conductivity of clay bound water can be calculated using, for example, equation (9) from Waxman and Smits (1968). In step 307.4, effects of fluids for different pores are added.

The end result at step 308 is that effective electrical properties of the rock are obtained.

It should be noted that in the calculations of the elastic and electrical properties of the rocks, rock/fluid parameters in both forward modeling workflows (FIGS. 2 and 3), e.g., microstructures (including aspect ratios and alignments) of different constituents, should be consistent from one workflow to the other. Additional details and example ways of performing some of the steps in FIG. 4 follow next.

In step 301, fluid conductivity can be estimated as functions of water saturation, temperature, pressure, fluid salinity, among others. Electrical properties of organic matter depend on the level of the maturity and can be obtained from laboratory experiments on the material, or using properties of coals as an analog. Input parameters of microstructure of pores and organic matter, e.g., aspect ratio and alignment, can be estimated from (for example) microscope photos, or 3D CT scanning images, or nanoscale images such as from focused ion beam (FIB) milling of rock samples, if available.

In steps 303 and 304, properties of the resistivity and conductive phases can be calculated respectively using a mixing process such as Voigt-Reuss-Hill averaging. It should be obvious that the order of performing the pair of steps 307.1-307.2 vs. the pair 307.3-307.4 is immaterial.

It may be noted that different phases such as quartz grains and clay particles can have different orientations, which needs to be taken into account in steps 305-307. Hence, orientations need to be taken into account in the calculation of the rock matrix using, for example, a rotation process disclosed by Xu and White (1998).

The calculated effective electrical properties (308) can be described using a conductivity tensor, or using parameters including horizontal and vertical resistivities or other properties derived from the aforementioned electrical parameters. The resistivity anisotropy may be represented through the ratio of vertical and horizontal components of resistivity (Rv/Rh).

### Inversion Determination of Tog—Theoretical Formulation

Source rock may be characterized by the volume concentrations of organic matter (i.e., V^{org}) and fluids (i.e., V^{ƒ}), which represents an actual, or “true” model. (See the left side of FIG. 10.) In embodiments of the inversion process of the present invention, velocity and resistivity measurements are input data, and TOC and porosity are unknown parameters to be inverted for. Parameters other than TOC and porosity are determined by a calibration process that precedes the inversion. To invert either or both of porosity and TOC from these two (velocity and resistivity) measurements, an effective medium is constructed that is described by a mathematical rock physics model of the type used in the forward modeling embodiments discussed previously. The inclusion space in the effective medium is assumed to be partly organic matter-filled and partly fluid-filled. An initial guess of V₀^{org} (or TOC₀) is made to start the inversion process. For elastic properties, organic matter may be treated as partly in the solid background and partly in the inclusion space, determined by a partitioning parameter α as described previously that can be obtained from a calibration process that precedes the inversion. For electrical properties, organic matter may be treated as resistive constituent. (See the right-hand side of FIG. 10.) If V₀^{org}=0 or (TOC₀=0), it means that whole inclusion space is filled with fluid. FIG. 10 is a representation of the “true” model using an effective model with initial guess of V₀^{org}. The drawing illustrates a difference between V^{ƒ} estimated from elastic properties and V^{ƒ} estimated from electrical properties, and it will be shown below that this difference can be converted to an estimate of V^{org}

Hence, effective rock properties of the effective medium can be characterized with the following generic expressions:

S_{V}^{eff}=ƒ_{V}(V₀^{org},V^{ƒ},other parameters), (5)

S_{R}^{eff}=ƒ_{R}(V₀^{org},V^{ƒ},other parameters), (6)

where S_{V}^{eff} are effective elastic properties and S_{R}^{eff} are effective electrical properties for the medium. Subscripts “V” and “R” denote the elastic and electrical properties, respectively. Function ƒ describes a rock physics model that handles the effects of organic matter and fluids, V^{org} and V^{ƒ} are the volume concentration of organic matter and fluids, respectively.

An estimate of V^{ƒ} can be obtained by minimizing the mismatch between the measurements and that calculated from the effective medium. Note that since elastic and electrical properties of source rocks are different from each other, an estimate of V^{ƒ} from the elastic properties is generally different from an estimate from electrical properties. Denote the estimate of V^{ƒ} from elastic properties as \tilde{V}_{V}^{ƒ} and that from electrical properties as \tilde{V}_{R}^{ƒ}.

Using the elastic properties, an estimate of V^{ƒ} (denoted as \tilde{V}_{V}^{ƒ}) can be obtained by minimizing the mismatch between the measured velocity from the true model and that calculated from the effective medium, S_{V}^{M} and S_{Y}^{eff}, where S_{V}^{M} represents the elastic properties from the measurement, i.e. the true model (see Equation 1). An objective function can be constructed as follows:

min{∥S_{V}^{eff}−S_{V}^{M}∥ₚ+λ∥\tilde{V}^{ƒ}∥_{q}}, (7)

where p and q indicate selected norms of the terms in the objective function, λ is a Lagrange multiplier to constrain the smoothness of the estimated \tilde{V}_{V}^{ƒ}.

Moreover, using the electrical properties, an estimate of V^{ƒ} (denoted as \tilde{V}_{R}^{ƒ}) can be obtained by minimizing the mismatch between the measured resistivity from the true model and that calculated from the effective medium, S_{R}^{M} and S_{V}^{eff}, where S_{R}^{M} represents the effective elastic properties of the true model (see Equation 2). An objective function can be constructed as follows:

min{∥S_{R}^{eff}−S_{R}^{M}∥_{P}+λ∥\tilde{V}_{R}^{ƒ}∥_{q}}. (8)

Volume concentrations of organic matter and fluid, V^{org} and V^{ƒ}, can be obtained from the inverted volume concentrations \tilde{V}_{V}^{ƒ} and \tilde{V}_{R}^{ƒ} using methods described as follows.

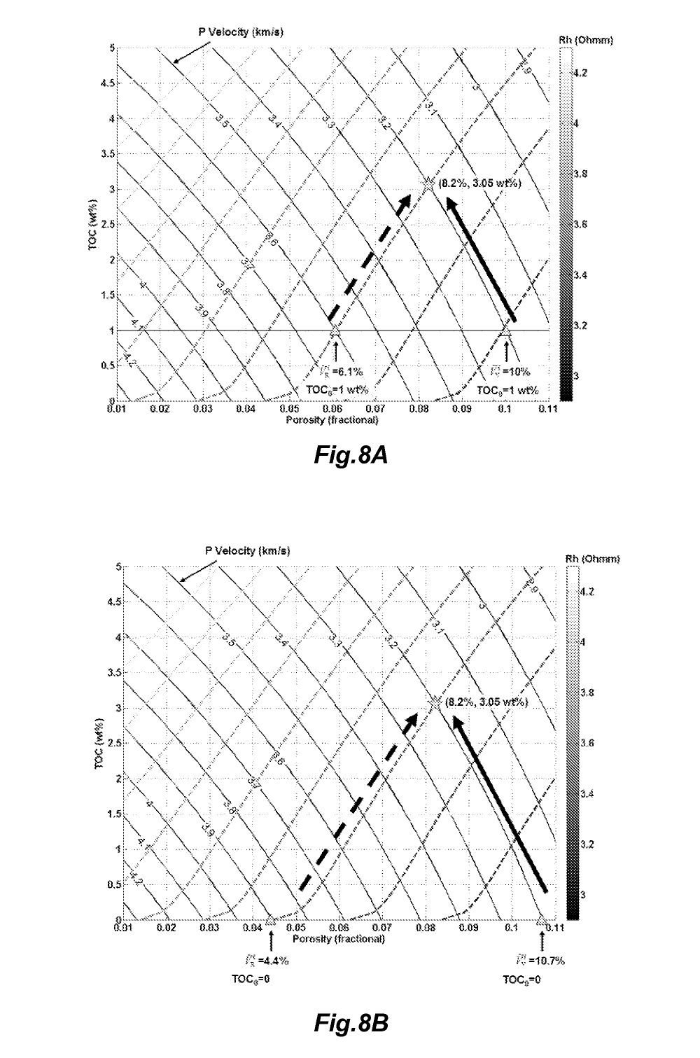

In a preferred embodiment of the invention, the relationship between the estimated fluid volume concentrations (V and) and true volume concentrations (V^{org} and V^{ƒ}) can be obtained numerically using a calibrated rock physics template, comprising the following basic steps, and referring to FIGS. 8A-B:

1) Calculate two classes of contours, i.e., the contours of the elastic and electrical properties, using a calibrated rock physics model (discussed below) and display them in a crossplot of fluid-related porosity and organic matter-filled volume as shown in FIGS. 8A-B. The solid-line curves are constant velocity contours, corresponding to the indicated values of P-wave velocity. The dashed lines are constant (horizontal) resistivity contours, with values of that parameter indicated by the color bar. (FIGS. 8A-B are gray scale reproductions of color displays due to patent restrictions on use of color.) The contours in FIG. 8A were generated assuming TOC₀=1 wt %, whereas FIG. 8B assumes TOC₀=0.

2) Estimate \tilde{V}_{V}^{ƒ} and \tilde{V}_{R}^{ƒ} by solving the inverse problems of Equations (7) and (8) separately, and display two estimated data points, i.e., (\tilde{V}_{V}^{ƒ}, V₀^{org}) and (\tilde{V}_{R}^{ƒ}, V₀^{org}) in the crossplot, as shown by two triangles in FIG. 8A.

3) Start from data point (V₀^{org}, \tilde{V}_{V}^{ƒ}) in the crossplot and track along the contour that corresponds to the elastic properties (the solid contour in FIG. 8A), and start from data point (V₀^{org}, \tilde{V}_{V}^{ƒ}) in the crossplot and track along the contour that corresponds to the electrical properties (the dashed contour in FIG. 8A).

4) Find a point A indicated by the star in FIG. 8A where the two tracked contours intersect.

5) Find an estimated fluid-related porosity and organic matter-filled volume from the cross-plot coordinates of point A (V^{ƒ},V^{org}). This approach using a calibrated rock physics template can be applied to generally anisotropic media.

The above process is repeated for the special case of V₀^{org}=0 (or TOC₀=0), where the estimated \tilde{V}_{V}^{ƒ} and \tilde{V}_{R}^{ƒ} in step 2 correspond to the two triangles in FIG. 8B, i.e., (\tilde{V}_{V}^{ƒ}, 0) and (\tilde{V}_{R}^{ƒ}, 0). It is noted that these two cases give substantially identical results for true porosity and TOC, indicating that the method is not sensitive to the initial guess for TOC.

The relationship between the inverted volume concentrations (\tilde{V}_{V}^{ƒ} and \tilde{V}_{R}^{ƒ}) and true volume concentrations (V^{org} and V^{ƒ}) can be used in step 422 in the inversion method described in the following sub-section.

In an alternative embodiment of the invention, the relationship between the estimated volume concentrations (\tilde{V}_{V}^{ƒ} and \tilde{V}_{R}^{ƒ}) and true volume concentrations (V^{org} and V^{ƒ}) can be obtained analytically using a linear approximation of the rock physics relationship for isotropic media. For the anisotropic case, a more rigorous method such as the cross-plot method of FIGS. 8A-B should be used.

For a given TOC₀, define the difference between \tilde{V}_{V}^{ƒ} and \tilde{V}_{R}^{ƒ} as

Δ\tilde{V}^{ƒ}=\tilde{V}_{V}^{ƒ}−\tilde{V}_{R}^{ƒ}. (9)

The relationship between Δ\tilde{V}^{ƒ} and true volume concentrations V^{org} and V^{ƒ} may be described as follows.

For elastic properties, consider solid substitution, which is a generalized form of the fluids substitution with the shear modulus of the fluids being zeros. Compliance tensors S_{V}^{M} and S_{V}^{eff} in the optimization problem (9) can be expressed as

$$\begin{matrix}{S}_{V , ijkl}^{M} = {S}_{ijkl}^{dry} - \frac{( {S}_{ijmn}^{dry} - {S}_{ijmn}^{g r} ) ( {S}_{klpq}^{dry} - {S}_{klpq}^{g r} )}{{[ ( 1 - α ) {V}^{org} ( {S}^{org} - {S}^{V} ) + ( {S}^{dry} - {S}^{g r} ) ]}_{mnpq}} - \frac{( {S}_{ijmn}^{dry} - {S}_{ijmn}^{g r} ) ( {S}_{klpq}^{dry} - {S}_{klpq}^{g r} )}{{[ {V}^{f} ( {S}^{f} - {S}^{V} ) + ( {S}^{dry} - {S}^{g r} ) ]}_{mnpq}} , \\ and & ( 10 ) \\ {S}_{V , ijkl}^{eff} = {\tilde{S}}_{ijkl}^{dry} - \frac{( {\tilde{S}}_{ijmn}^{dry} - {\tilde{S}}_{ijmn}^{g r} ) ( {\tilde{S}}_{klpq}^{dry} - {\tilde{S}}_{klpq}^{g r} )}{{[ ( 1 - α ) {V}_{0}^{org} ( {S}^{org} - {\tilde{S}}^{V} ) + ( {\tilde{S}}^{dry} - {\tilde{S}}^{g r} ) ]}_{mnpq}} - \frac{( {\tilde{S}}_{ijmn}^{dry} - {\tilde{S}}_{ijmn}^{g r} ) ( {\tilde{S}}_{klpq}^{dry} - {\tilde{S}}_{klpq}^{g r} )}{{[ {\tilde{V}}^{f} ( {S}^{f} - {\tilde{S}}^{V} ) + ( {\tilde{S}}^{dry} - {\tilde{S}}^{g r} ) ]}_{mnpq}} , & ( 11 )\end{matrix}$$

where α is the partitioning parameter, Sᵢⱼₖₗ^{gr}, Sᵢⱼₖₗ^{V}, and Sᵢⱼₖₗ^{dry} are, respectively, the compliance tensors of the grain mineral, inclusion space, and rock matrix for the true model. \tilde{S}ᵢⱼₖₗ^{gr}, \tilde{S}ᵢⱼₖₗ^{V}, and \tilde{S}ᵢⱼₖₗ^{dry} are, respectively, the compliance tensors of the grain mineral, inclusion space, and rock matrix for the effective medium. Note that and Sᵢⱼₖₗ^{gr} depends on the volume of organic matter treated as part of the solid background, αV^{org}, and depends on the initial guess of volume αV₀^{org}. Also note that and Sᵢⱼₖₗ^{dry} depends on the inclusion space including (1−α)V^{org} and V^{ƒ}, and and \tilde{S}ᵢⱼₖₗ^{dry} depends on the initial guess of volume (1−α)V₀^{org} and the estimated volume \tilde{V}_{V}^{ƒ} for the effective medium. For brevity, the subscripts “V” of all compliance tensors on the right-hand sides of Equations (10-11) (and the following Equation 12 as well) are omitted.

Solving Equations (10) and (11) by minimizing the difference between S_{V}^{ƒ} and S_{V}^{eff} yields the estimated \tilde{V}_{V}^{ƒ} that depends on V^{org}, V₀^{org}, and V^{ƒ}. For example, setting Eqs. (10) and (11) equal to each other yields (with the subscripts “V” of all compliance tensors omitted)

$${S}_{ijkl}^{dry} - \frac{( {S}_{ijmn}^{dry} - {S}_{ijmn}^{g r} ) ( {S}_{klpq}^{dry} - {S}_{klpq}^{g r} )}{{[ {V}^{org} ( {S}^{org} - {S}^{V} ) + ( {S}^{dry} - {S}^{g r} ) ]}_{mnpq}} - \frac{( {S}_{ijmn}^{dry} - {S}_{ijmn}^{g r} ) ( {S}_{klpq}^{dry} - {S}_{klpq}^{g r} )}{{[ {V}^{f} ( {S}^{f} - {S}^{V} ) + ( {S}^{dry} - {S}^{g r} ) ]}_{mnpq}} = {S}_{ijkl}^{dry} - \frac{( {\tilde{S}}_{ijmn}^{dry} - {\tilde{S}}_{ijmn}^{g r} ) ( {\tilde{S}}_{klpq}^{dry} - {\tilde{S}}_{klpq}^{g r} )}{{[ ( 1 - α ) {V}_{0}^{org} ( {S}^{org} - {\tilde{S}}^{V} ) + ( {\tilde{S}}^{dry} - {\tilde{S}}^{g r} ) ]}_{mnpq}} - \frac{( {\tilde{S}}_{ijmn}^{dry} - {\tilde{S}}_{ijmn}^{g r} ) ( {\tilde{S}}_{klpq}^{dry} - {\tilde{S}}_{klpq}^{g r} )}{{[ {\tilde{V}}^{f} ( {S}^{f} - {\tilde{S}}^{V} ) + ( {\tilde{S}}^{dry} - {\tilde{S}}^{g r} ) ]}_{mnpq}} . \qquad ( 12 )$$

For electrical properties, S_{R}^{M} and S_{R}^{eff} in the optimization problem (8) can be obtained using the Willis equation (Equation (3.16) in his cited 1977 paper) as follows:

$$\begin{matrix}{S}_{R}^{M} = \frac{\begin{matrix}{V}^{org} {{L}^{org} [ I + {P}_{0} ( {L}^{org} - {L}^{0} ) ]}^{- 1} + \\ {V}^{f} {{L}^{f} [ I + {P}_{0} ( {L}^{f} - {L}^{0} ) ]}^{- 1} + \\ ( 1 - {V}^{org} - {V}^{f} ) {{L}^{g r} [ I + {P}_{0} ( {L}^{g r} - {L}^{0} ) ]}^{- 1}\end{matrix}}{\begin{matrix}{{V}^{org} [ I + {P}_{0} ( {L}^{org} - {L}^{0} ) ]}^{- 1} + \\ {{V}^{f} [ I + {P}_{0} ( {L}^{f} - {L}^{0} ) ]}^{- 1} + \\ {( 1 - {V}^{org} - {V}^{f} ) [ I + {P}_{0} ( {L}^{g r} - {L}^{0} ) ]}^{- 1}\end{matrix}} and & ( 13 ) \\ {S}_{R}^{eff} = \frac{\begin{matrix}{V}_{0}^{org} {{L}^{org} [ I + {P}_{0} ( {L}^{org} - {L}^{0} ) ]}^{- 1} + \\ {\tilde{V}}^{f} {{L}^{f} [ I + {P}_{0} ( {L}^{f} - {L}^{0} ) ]}^{- 1} + \\ ( 1 - {V}_{0}^{org} - {\tilde{V}}^{f} ) {{L}^{g r} [ I + {P}_{0} ( {L}^{g r} - {L}^{0} ) ]}^{- 1}\end{matrix}}{\begin{matrix}{{V}_{0}^{org} [ I + {P}_{0} ( {L}^{org} - {L}^{0} ) ]}^{- 1} + \\ {{\tilde{V}}^{f} [ I + {P}_{0} ( {L}^{f} - {L}^{0} ) ]}^{- 1} + \\ {( 1 - {V}_{0}^{org} - {V}^{f} ) [ I + {P}_{0} ( {L}^{g r} - {L}^{0} ) ]}^{- 1}\end{matrix}} & ( 14 )\end{matrix}$$

where I is the unit tensor, L⁰ is the property tensor of a reference medium as discussed in Willis's (1977) method, P₀ is a tensor that is a function of pore geometry and the properties of the reference medium, V₀^{org} is the initial guess of organic matter-filled volume that is the same as in Equation (11), and V₀^{org} is the estimated inclusion space for the effective medium for a given TOC₀. Here the same reference medium is chosen for Equations (13) and (14). For brevity, the subscripts “R” of all tensors at the right-hand sides of Equations (13-14) are omitted.

Solving Equations (13) and (14) by minimizing the difference between SR and S_{R}^{eff} yields the estimated \tilde{V}_{R}^{ƒ} that depends on V^{org}, V₀^{org}, and V^{ƒ}. For example, setting them equal to each other yields (with the subscripts “R” of all tensors omitted)

$$\frac{\begin{matrix}{V}^{org} {{L}^{org} [ I + {P}_{0} ( {L}^{org} - {L}^{0} ) ]}^{- 1} + \\ {V}^{f} {{L}^{f} [ I + {P}_{0} ( {L}^{f} - {L}^{0} ) ]}^{- 1} + \\ ( 1 - {V}^{org} - {V}^{f} ) {{L}^{g r} [ I + {P}_{0} ( {L}^{g r} - {L}^{0} ) ]}^{- 1}\end{matrix}}{\begin{matrix}{{V}^{org} [ I + {P}_{0} ( {L}^{org} - {L}^{0} ) ]}^{- 1} + \\ {{V}^{f} [ I + {P}_{0} ( {L}^{f} - {L}^{0} ) ]}^{- 1} + \\ {( 1 - {V}^{org} - {V}^{f} ) [ I + {P}_{0} ( {L}^{g r} - {L}^{0} ) ]}^{- 1}\end{matrix}} = \frac{\begin{matrix}{V}_{0}^{org} {{L}^{org} [ I + {P}_{0} ( {L}^{org} - {L}^{0} ) ]}^{- 1} + \\ {\tilde{V}}^{f} {{L}^{f} [ I + {P}_{0} ( {L}^{f} - {L}^{0} ) ]}^{- 1} + \\ ( 1 - {V}_{0}^{org} - {\tilde{V}}^{f} ) {{L}^{g r} [ I + {P}_{0} ( {L}^{g r} - {L}^{0} ) ]}^{- 1}\end{matrix}}{\begin{matrix}{{V}_{0}^{org} [ I + {P}_{0} ( {L}^{org} - {L}^{0} ) ]}^{- 1} + \\ {{\tilde{V}}^{f} [ I + {P}_{0} ( {L}^{f} - {L}^{0} ) ]}^{- 1} + \\ {( 1 - {V}_{0}^{org} - {\tilde{V}}_{R}^{f} ) [ I + {P}_{0} ( {L}^{g r} - {L}^{0} ) ]}^{- 1}\end{matrix}} \qquad ( 15 )$$

An analytical relationship between Δ\tilde{V}R^{ƒ} and true volume concentrations V^{org} and V^{ƒ} can be obtained for effective isotropic media with a small volume concentration of inclusions, where Equations (12) and (15) can be linearized to obtain \tilde{V}_{V}^{ƒ} and \tilde{V}_{R}^{ƒ} as functions of V^{org} and V^{ƒ}. The estimated volume concentrations of the inclusions using sonic and resistivity properties can be expressed as

$$\begin{matrix}{\tilde{V}}_{V}^{f} = \frac{( 1 - α ) {B}_{V}^{org} + α {C}_{V}^{org}}{{B}_{V}^{f}} ( {V}^{org} - {V}_{0}^{org} ) + {V}^{f} \\ ( for sonic properties ) , and & ( 16 ) \\ {\tilde{V}}_{R}^{f} = \frac{{B}_{R}^{org}}{{B}_{R}^{f}} ( {V}^{org} - {V}_{0}^{org} ) + {V}^{f} \\ ( for resistivity properties ) , & ( 17 )\end{matrix}$$

where V^{org} and V^{ƒ} are, respectively, the volume concentrations of organic matter and fluid, i.e. the desired unknown quantities. For the cases where multiple phases of fluids co-exist in the inclusion space, effective properties of the fluid mixture depend on the fluid saturation and can be estimated using a mixing law such as the Wood Suspension model. Coefficients B_{V}^{org}, C_{V}^{org}, and B_{R}^{org} depend on the properties of the solid background, the organic matter, and the microstructure of the inclusion space. Coefficients B_{V}^{ƒ} and B_{R}^{ƒ} depend on the properties of the solid background, the fluid, and the microstructure of the inclusion space. In general, the ratio

$$\frac{( 1 - α ) {B}_{V}^{org} + α {C}_{V}^{org}}{{B}_{V}^{f}} \leq 1$$

since organic matter has higher modulus than fluids.

For effective isotropic media, coefficients B_{V}^{org}, C_{V}^{org}, B_{R}^{org}, B_{V}^{ƒ}, and B_{R}^{ƒ} can be solved analytically. For example, in the special case of effective isotropic media, one can use the bulk modulus from Kuster and Toksoz (1974) equation [Equation (41)] to obtain

$$\begin{matrix}{B}_{V}^{org} = \frac{{T}_{V}^{org}}{3} - \frac{{( \frac{{T}_{V}^{org}}{3} )}^{2}}{\frac{1 - {c}_{V}^{org}}{{c}_{V}^{org}} + \frac{{T}_{V}^{org}}{3}} , and & ( 18 ) \\ {B}_{V}^{f} = \frac{{T}_{V}^{f}}{3} - \frac{{( \frac{{T}_{V}^{f}}{3} )}^{2}}{\frac{1 - {c}_{V}^{f}}{{c}_{V}^{f}} + \frac{{T}_{V}^{f}}{3}} , & ( 19 )\end{matrix}$$

where c_{V}^{org} and c_{V}^{ƒ} are, respectively, ratios of the bulk modulus of organic matter and fluid to that of the solid background. T_{V}^{org} and T_{V}^{ƒ} are geometric functions of the inclusions that are filled with organic matter and fluid, respectively. The geometric functions depend on the shape of the inclusion, which can be described as in Kuster and Toksoz (1974). Coefficient C_{V}^{org} depends on the ratio of the modulus of organic matter to that of other solid minerals in the solid background (denoted as c_{V}′^{org}). For example, using Voigt-Reuss-Hill averaging, one gets

$${C}_{V}^{org} = \frac{1}{2 {V}^{os}} ( {c}_{V}^{′ org} - \frac{1}{{c}_{V}^{′ org}} ) ,$$

where V^{os} is the volume concentration of other solid minerals in the background and is dimensionless. (Note that c_{V}′^{org} is not the same as c_{V}^{org} in Equation 18.) If c_{V}′^{org}=1, the modulus of the solid background does not change with the volume of organic matter that is treated as part of the background, and one gets C_{V}^{org}=0.

Using electrical properties from equation (14) in Shafiro and Kachanov (2000), one obtains

B_{R}^{org}=α_{R}^{org}(1−c_{R}^{org}), (20)

and

B_{R}^{ƒ}=α_{R}^{ƒ}(1−c_{R}^{ƒ}), (21)

where c_{R}^{org} and c_{R}^{ƒ} are, respectively, the ratio of the conductivity of organic matter and fluid to that of the solid background, α_{R}^{org} and α_{R}^{ƒ} and of are geometric functions of the inclusions that are filled with organic matter and fluid, respectively. These functions can be obtained from Willis's (1977) method. They also depend on the choice of the reference media.

It should be noted that estimated results depend on the geometric structure (shape) and spatial alignment of the inclusions, and also that properties of organic matter vary significantly with many factors including the maturity. If the volume concentration of organic matter is estimated using fluids that have similar properties to organic matter, the estimated volume concentration is similar to the true volume concentration of organic matter. For example, if organic matter has high resistivity and hydrocarbons are used to estimate V^{org}, the estimated result has \tilde{V}_{R}^{ƒ}≈V^{org}−V₀^{org}+V^{ƒ}. If organic matter has high resistivity and brine with high salinity is used to estimate V^{org}, the estimated result has \tilde{V}_{R}^{ƒ}≈V^{ƒ}.

From Equations (16) and (17), one gets

$$\begin{matrix}Δ {\tilde{V}}^{f} = {\tilde{V}}_{V}^{f} - {\tilde{V}}_{R}^{f} \\ = ( \frac{( 1 - α ) {B}_{V}^{org} + α {C}_{V}^{org}}{{B}_{V}^{f}} - \frac{{B}_{R}^{org}}{{B}_{R}^{f}} ) ( {V}^{org} - {V}_{0}^{org} ) ,\end{matrix} \qquad ( 22 )$$

which suggests that the difference between estimated volume concentrations from sonic and resistivity properties can be used for evaluating the volume concentration of organic matter. Hence, V^{org} can be obtained from Δ\tilde{V}^{ƒ} using Equation (22). It may be noted that for source rocks, V^{org} represents the volume filled with organic matter of the true model. For non-source rocks (i.e., no organic matter present), V^{org}=0 (and hence Vₒ^{org} is set to 0), which suggests that the estimated \tilde{V}_{V}^{ƒ} is the same as V_{R}^{ƒ} and hence Δ\tilde{V}^{ƒ}=0. As illustrated in FIGS. 8A-B, Δ\tilde{V}^{ƒ} is measured by the separation between the two triangles and (V^{org}−V₀^{org}) is measured by the separation between the star and the line that connects two triangles.

The volume concentration of organic matter can then be converted to TOC in weight percentage:

TOC=χ·V^{org}, (23)

where χis a conversion factor defined as, for example, the density ratio between fluid and organic matter:

$$χ = \frac{{ρ}^{f}}{{ρ}^{k}} , \qquad ( 24 )$$

where ρ^{ƒ} is the effective density of the fluid, which depends on the water saturation, and ρ^{k} is the density of the organic matter. It will be readily recognized that conversion of volume percent to weight percent can occur at any earlier point in the method, and therefore that references to “volume concentration” in the application, including the claims, shall be understood to refer equally to equivalent weight percent.

Basic steps of the TOC inversion embodiments of the invention are described next, with reference to the flow chart of FIG. 5. As indicated in FIG. 5, the method begins with calibration of the rock physics relationship (steps 401-408), and is followed by the inversion (steps 409-423).

In step 401, certain representative intervals are selected for the calibration, where the intervals are known from well logs to be either source rocks or non-source rocks in the area of interest. In step 402, all necessary data and parameters for the calibration are collected and prepared. The symmetry orientation of the rock (defined with the dip angle θᵣ and azimuthal direction ψᵣ) and wellbore orientation (defined with the deviation (from vertical) angle φ_{w} and azimuthal direction ψ_{w}) are also determined.

In step 403, a mathematical expression for a rock physics model is determined. The requirements for this TOC model are the same as for the model of step 101 in FIG. 2. The TOC model needs to be anisotropic when calibrated with log data from either a deviated well or from a vertical well penetrating dipping layers, or both; or for sedimentary rock regardless of well geometry because sedimentary rocks behave effectively anisotropic. Otherwise, the TOC model may be isotropic. In step 404, the log responses are calculated using the rock physics model. The calculated log responses may include P- and S-wave sonic logs, density, resistivity, and velocity and resistivity anisotropy logs, if available. The log responses are calculated on local coordinates characterized by the symmetry direction and the bedding plane of the rock. In step 405, log responses (elastic and electrical) are calculated by rotating the elasticity and electricity tensors by the angle between the wellbore orientation and the symmetry orientation of the rock (which can be expressed as φ_{w}−θᵣ if the wellbore orientation and the symmetry orientation of the rock have the same azimuth).

In step 406, the calculated log responses are compared with measurements. If the comparison results in a misfit that is larger than a selected tolerance, then in step 407 the method adjusts one or more input parameters of the rock physics model (e.g., pore aspect ratio and orientation) and then returns to step 402, after which the log responses are recalculated using the updated model. This calibration process is repeated until the calculated logs satisfactorily fit the measured, or another stopping condition is met. The eventual result is a calibrated anisotropic rock physics model at step 408.

At step 409, one or more target intervals are selected for the inversion. At step 410, choose a background value of TOC, called TOC₀ (or the volume concentration of organic matter V₀^{org}), which may or may not be zero. Note that if TOC₀ is chosen to be 0, then the model used in the inversion process does not have to be able to treat organic matter until step 421. A simpler model can be used such as that described in patent application WO2009/12635. At step 411, the fluid properties used in the inversion are estimated using, for example, Batzle and Wang (1994).

Next, two independent inversions are performed. Both use the calibrated rock physics model from step 408. In inversion loop 441, measured sonic log data are inverted to infer an estimate of \tilde{V}^{ƒ} (steps 412-420.1). In inversion loop 442, measured resistivity log data are inverted to estimate \tilde{V}_{R}^{ƒ} (steps 414.2-420.2).

Inversion 441 begins at step 412 where, if TOC₀ is chosen to be zero, the process moves to step 414.1, and if TOC₀≠0, to 413 where a partition parameter α is chosen based on the calibration process, then moving to step 414.1. At step 414.1, an initial guess is made for \tilde{V}_{V}^{ƒ}. In steps 415.1 and 416.1, the calibrated rock physics model from 408 is used to predict the sonic properties corresponding to the assumed value of \tilde{V}_{V}^{ƒ}. The sonic responses are calculated on local coordinates characterized by the symmetry direction and the bedding plane of the rock (as shown in FIG. 8). In step 417.1, the sonic responses are calculated along the wellbore where measured sonic logs were obtained, by rotating with the angle between the wellbore orientation and the symmetry orientation of the rock. In step 418.1, the calculated sonic properties are compared with corresponding well log measurements. If the misfit between the measured and the calculated is larger than a selected tolerance, then \tilde{V}_{V}^{ƒ} is updated (step 419.1) and the process is repeated with the updated value of \tilde{V}_{V}^{ƒ}. This iterative inversion process continues until the calculated and measured logs agree within a selected tolerance, or another stopping condition is met. The eventual result is an estimated \tilde{V}_{V}^{ƒ} at step 420.1.

Inversion 442 follows a similar sequence of steps except that resistivity inversion is not affected by α. In step 414.2, an initial guess of \tilde{V}_{R}^{ƒ} is made. In steps 415.2-416.2, the calibrated rock physics model is used to predict the resistivity properties corresponding to the assumed value of \tilde{V}_{R}^{ƒ}. The resistivity responses are calculated on local coordinates characterized by the symmetry direction and the bedding plane of the rock (as shown in FIG. 8). In step 417.2, the resistivity responses are calculated along the wellbore where measured resistivity logs were obtained, by rotating with the angle between the wellbore orientation and the symmetry orientation of the rock. In step 418.2, the calculated resistivity properties are compared with corresponding well log measurements. If the misfit between the measured and the calculated is larger than a selected tolerance, then \tilde{V}_{R}^{ƒ} is updated (step 419.2) and the process is repeated with the updated value of \tilde{V}_{R}^{ƒ}. This iterative inversion process continues until the calculated and measured logs agree within a selected tolerance, or another stopping condition is met. The eventual result is an estimated \tilde{V}_{R}^{ƒ} at step 420.2.

At step 421, the difference between the estimated \tilde{V}_{V}^{ƒ} from step 420.1 and the estimated \tilde{V}_{R}^{ƒ} from step 420.2 is calculated. This volume difference, Δ\tilde{V}_{V}^{ƒ}, is converted to a volume concentration of organic matter, V^{org}, in step 422. Depending upon the need for treating anisotropy, this may be done using a numerical approach based on a rock physics template based on the calibrated rock physics model (discussed above in connection with FIGS. 8A-B), or the analytical linearization approach discussed in connection with Equations (9)-(22) or any equivalent method. It should be noted that this step cannot be performed without benefit of a rock physics model that can handle organic matter. At step 423, V^{org} may be converted to TOC, which may be done using Equations (23) and (24).

In step 410 and the inversion steps that follow, no knowledge on the volume concentration of organic matter is required other than in making the initial guess in steps 412-413, where a good guess can speed up the iteration loop 441. The estimate of the volume concentration of the inclusions combines the effects from the fluid-filled inclusions and organic matter-filled inclusions.

In steps 416.1-418.1, sonic (i.e., acoustic) properties may include, but are not limited to, P- and shear wave velocities, density, and/or anisotropy. In steps 416.2-418.2, electrical properties may include, but are not limited to, horizontal resistivity, vertical resistivity, and/or anisotropy.

### EXAMPLE

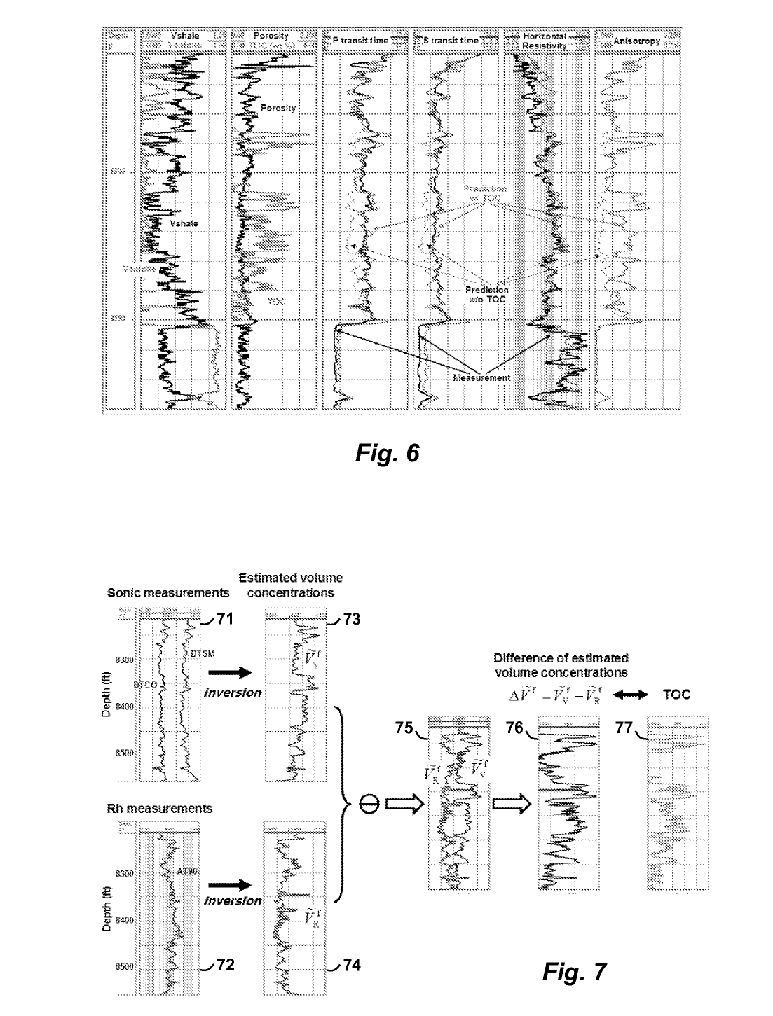

The result of applying rock physics modeling for a shale gas formation is shown in FIG. 6, where various quantities are plotted vs. depth. The left panel shows volumes of shale (Vshale, black curve) and calcite (Vcalcite, gray curve) that are obtained from petrophysical analysis. The second panel shows porosity (black curve, in volume percent) that indicates the volume concentration of fluids, and TOC (gray curve, in weight percent) that indicates the concentration of organic matter. Elastic properties of organic matter are obtained from an analog of coal material. The next three panels compare the log measurements (black) with two prediction results: prediction with (gray curves) and without (black dashed curves) the consideration of organic matter. The gray curves were generated by forward modeling using the present inventive method, with TOC derived from an independent analysis using formation evaluation technique. The log quantities shown are P-wave sonic transit time in units of μs/ft, shear(S)-wave sonic transit time in units of μs/ft, and horizontal resistivity in units of ohm·m. The far right panel shows the velocity anisotropy parameter ε as calculated by the present inventive method.

It can be deduced from the TOC display that organic-rich intervals are mainly confined to depth range of 8225-8550 ft. At depth below 8550 ft, the organic-rich intervals end, and a carbonate formation is encountered.

For the prediction with the consideration of organic matter (gray curves), a forward modeling workflow as described in FIGS. 2 and 3 was implemented and organic matter is considered as part of the inclusion space. Also in the inclusion space are fluids characterized with water saturation. Clay pores are assumed to be fully saturated with bound water. For the prediction without the consideration of organic matter (prediction w/o TOC, black dashed curves), a forward modeling workflow is implemented by setting the volume concentration of organic matter at zero (TOC=0) and such space is then occupied with solid background.

It can be seen that the prediction with the consideration of organic matter generally matches the log measurements. Comparison between modeling results with and without the consideration of TOC indicates significant differences for sonic properties, which confirms the necessity of appropriate handling of TOC effects in log prediction and seismic inversion of rock/fluid properties.

The reduction of sonic velocities in organic-rich intervals is partially offset by the presence of silicon minerals in this formation. The modeling results also show significant increase of velocity anisotropy in organic-rich intervals, which is possibly due to the small aspect ratio and good alignment of laminated organic matter. Velocity anisotropy is shown in the right-most panel in FIG. 6.

In the resistivity results, predictions with and without the consideration of organic matter show negligible difference, possibly because of the relatively high resistivity of organic matter that is comparable to that of the solid minerals.

The different effect of organic matter on sonic and resistivity reveals the physics behind the present inventive method of inverting TOC from sonic and resistivity properties using a calibrated rock physics relationship. Since the effects of organic matter on sonic and resistivity are different, estimates of inclusion volume using sonic and resistivity are different, which can be used to estimate the true volume concentration of organic matter using a numerical or an analytical approach.

FIG. 7 shows an application of an inversion embodiment of the present invention, step-by-step. The same log data is used as in FIG. 6, and FIG. 7 shows how the TOC estimation in the second panel of FIG. 6 was generated. After the calibration of the rock physics model by selecting non-source rock intervals, the volume concentration \tilde{V}_{V}^{ƒ} was inverted from sonic logs and \tilde{V}_{R}^{ƒ} from resistivity logs. The sonic logs 71 include density (not shown), P-wave sonic (DTCO) and S-wave sonic logs (DTSM). The resistivity log 72 is horizontal resistivity (AT90). Graphs 73 and 74 show the estimated \tilde{V}_{V}^{ƒ} and \tilde{V}_{R}^{ƒ}, respectively. Graph 75 displays both \tilde{V}_{V}^{ƒ} and \tilde{V}_{R}^{ƒ}, and graph 76 displays the difference of estimated volume concentrations, Δ\tilde{V}^{ƒ}=\tilde{V}_{V}^{ƒ}−\tilde{V}_{R}^{ƒ}, which can be converted to TOC, as shown in 77.

The foregoing application is directed to particular embodiments of the present invention for the purpose of illustrating it. It will be apparent, however, to one skilled in the art, that many modifications and variations to the embodiments described herein are possible. All such modifications and variations are intended to be within the scope of the present invention, as defined in the appended claims.

### REFERENCES

Batzle, M., and Z. Wang (1994) “Seismic Properties of Pore Fluids: Geophysics, 57, pp. 1396-1408.
Bayuk, I. O., M. Ammerman, and E. M. Chesnokov (2008) “Upscaling of Elastic Properties of Anisotropic Sedimentary Rocks.” Geophysical Journal International, 172, pp. 842-860.
Brown, R., and J. Korring a (1975) “On the Dependence of the Elastic Properties of a Porous Rock on the Compressibility of the Pore Fluid,” Geophysics, 40, pp. 608-616.
Ciz, R., and S. Shapiro (2007) “Generalization of Gassmann Equations for Porous Media Saturated With a Solid Material,” Geophysics, 72, pp. A75-A79.
Drxge, A., M. Jakobsen, and T. Johansen (2006) “Rock Physics Modeling of Shale Diagenesis,” Petroleum Geoscience, 12, pp. 49-57.
Gassmann, F. (1951) “Uber Die Elastizität Poröser Medien,” Vier. der Natur. Gesellschaft in Zürich, 96, pp. 1-23.
Hornby, B., L. M. Schwartz, and J. A. Hudson (1994) “Anisotropic Effective-Medium Modeling of the Elastic Properties of Shales,” Geophysics, 59 (10), pp. 1570-1583.
Keys, R. G. and S. Xu (2002) “An Approximation for the Xu-White Velocity Model,” Geophysics, 67, pp. 1406-1414.
Kuster, G. T., and M. N. Toksoz (1974) “Velocity and Attenuation of Seismic Waves in Two Phase Media, Part 1: Theoretical Formulation,” Geophysics, 39, pp. 587-606.
Passey, Q. R., S. Creaney, J. B. Kulla, F. J. Moretti, and J. D. Stroud (1990) “A Practical Model for Organic Richness from Porosity and Resistivity Logs,” American Association of Petroleum Geologists Bulletin, 74, pp. 1777-1794.
Sayers, C. M. (2005) “Seismic Anisotropy of Shales,” Geophysical Prospecting, 53, pp. 667-676.
Shafiro, B., and M. Kachanov (2000) “Anisotropic Effective Conductivity of Materials With Nonrandomly Oriented Inclusions of Diverse Ellipsoidal Shapes,” Journal of Applied Physics, 87, pp. 8561-8569.
Thomsen, L. (1986) “Weak Elastic Anisotropy,” Geophysics, 51, pp. 1954-1966.
Vernik, L, and X Liu (1997) “Velocity Anisotropy in Shales: A Petrophysical Study,” Geophysics, 62, pp. 521-532.
Waxman, M. H., and L. J. M. Smits (1968) “Electrical Conductivities in Oil-Bearing Shaley Sands,” The Society of Petroleum Journal, 8, pp. 107-122.
Willis, J. R. (1977) “Bounds and Self-Consistent Estimates for the Overall Properties of Anisotropic Composite,” Journal of Mechanics and Physics of Solids, 25, pp. 185-202.
Xu, S., G. Chen, Y. Zhu, J. Zhang, M. A. Payne, M. Deffenbaugh, L. Song, and J. Dunsmuir (2007) “Carbonate Rock Physics: Analytical Models and Validations Using Computational Approaches and Lab/Log Measurements,” IPTC, paper IPTC-11308-PP.
Xu, S., Saltzer, R. L. and Keys, R. G. (2008) “Integrated Anisotropic Rock Physics Model,” US Patent Application Publication Number US/2008/0086287.
Xu, S., and R. E. White (1995) “A New Velocity Model for Clay-Sand Mixture,” Geophysical Prospecting, 43, pp. 91-118.
Xu, S., and R. E. White (1998) “Permeability Prediction in Anisotropic Shaly Formations, In Core-Log Integration,” London Geological Society Special Publication No 136, pp. 225-236.

1. A computer-implemented method for predicting anisotropic elastic or electrical properties of a source rock formation comprising:
constructing an inclusion-based mathematical rock physics model that treats organic matter as solid inclusions, or partly solid inclusions and partly solid background for calculating elastic properties, and as a resistive phase of the source rock for calculating electrical properties, and relates anisotropic elastic or electrical properties of source rock to in-situ rock and fluid properties; and
using the rock physics model to calculate effective elastic properties or effective electrical properties of the source rock formation.

2. The method of claim 1, wherein the rock physics model is constructed by steps comprising:
(a) choosing a mathematical form of a rock physics model relating anisotropic elastic or electrical properties to in-situ rock properties of source rocks including properties of organic matter, wherein said model has a rock matrix consisting of solid background and inclusion space; and
(b) evaluating constant terms in the mathematical model for the source rock formation by steps including:
determining a partitioning parameter specifying organic matter distribution between the solid background and the inclusion space, and partitioning the inclusion space into fluid-filled pores and organic matter-filled inclusions;
constructing the rock matrix using the partitioned inclusion space and the solid background; and
obtaining properties of fluid-filled pores and organic matter-filled volumes.

3. The method of claim 2, wherein said properties of fluid-filled pores and organic matter-filled volumes include volume concentration of fluids and organic matter, their elastic or electrical properties, and geometrical structures including shape and spatial alignment of inclusions.

4. The method of claim 1, wherein said rock and fluid properties include pore aspect ratio, pore orientation, porosity, shale volume fraction, total organic carbon (TOC), and water saturation.

5. The method of claim 1, wherein:
effects of organic matter on elastic properties are calculated using solid substitution or a mixing law and fluid effects on elastic properties are calculated either by using fluid substitution or by a solid substitution process by setting the shear moduli of fluids to zero; and
effects of organic matter and fluids on electrical properties are calculated by adding organic matter and fluids as different constituents to the rock physics model's rock matrix.

6. The method of claim 2, wherein the partitioning parameter specifying organic matter distribution between the solid background and the inclusion space has a value falling in a range being ≧0 and <1, where the value 0 corresponds to all organic matter being in the inclusion space, and the value 1 corresponds to all organic matter being in the solid background, and intermediate values of the partitioning parameter correspond proportionally to the organic matter being distributed between the inclusion space and the solid background.

7. The method of claim 2, wherein properties of the solid background are calculated using organic matter and other solid mineral particles if the solid background includes organic matter, whereas properties of the solid background are calculated using solid mineral particles without organic matter if organic matter is included only in the inclusion space.

8. The method of claim 2, wherein the inclusion space comprises fluid-filled pores and organic matter-filled volumes to the extent that the inclusion space includes organic matter.

9. The method of claim 2, wherein partitioning the inclusion space into fluid-filled pores and organic matter-filled inclusions depends on volume concentrations and spatial distributions of fluids and inclusion-filling organic matter.

10. The method of claim 9, wherein the spatial distribution of fluids and organic matter is determined from observations of microscopic structure of source rocks.

11. The method of claim 2, wherein the partitioning of the inclusion space further comprises partitioning of different types of fluid-filled pores including inter-particle pores, intra-particle pores, cracks, clay bounded pores, and fluid-filled pores within organic matter.

12. The method of claim 2, wherein if part of the inclusion space is filled with a mixture of fluids and organic matter, fluids and organic matter are treated separately or are mixed with each other to form an the effective medium by using a mixing law.

13. The method of claim 2, wherein at least some of the properties of fluid-filled pores and organic matter-filled volumes are obtained from well data, wherein the term well data includes well logs or core analyses or both from at least one well into the source rock formation.

14. A computer-implemented method for predicting total organic carbon, called TOC, of a source rock formation, comprising inverting sonic and resistivity log data and determining TOC in terms of a difference between elastic and electrical properties of the source rock.

15. The method of claim 14, wherein said difference between elastic and electrical properties of the source rock is a difference between two model inversion estimates of volume concentration of fluids, one estimate obtained by inverting sonic log data and the other obtained by inverting resistivity log data.

16. The method of claim 15, wherein both of the two model inversions use a calibrated inclusion-based mathematical rock physics model that relates anisotropic elastic and electric properties of source rock to in-situ rock and fluid properties of source rock including properties of organic matter, wherein said model has a rock matrix consisting of solid background and inclusion space and is able to treat source rock having organic content that is solid, fluid, or both, and treats organic matter as solid inclusions or solid background or both, and as a resistive phase of the source rock, and wherein the rock physics model is calibrated using well data, the term well data including well logs or core analyses or both from at least one well penetrating the source rock formation.

17. The method of claim 16, wherein said determining TOC in terms of a difference between two model inversion estimates of volume concentration of fluids comprises using the calibrated inclusion-based mathematical rock physics model to convert the difference between the estimated volume concentrations to a volume concentration of organic matter, which is then converted to a TOC weight percent.

18. The method of claim 17, wherein the conversion of the difference between the estimated volume concentrations to a volume concentration of organic matter is performed numerically using a rock physics template.

19. The method of claim 18, wherein the rock physics template comprises a crossplot of TOC vs. porosity.

20. The method of claim 17, wherein the source rock formation is assumed to be isotropic and the difference between the estimated volume concentrations is converted to a volume concentration of organic matter by solving an analytical relationship based on a linear approximation of the mathematical rock physics model for isotropic media.

21. The method of claim 20, wherein the analytical relationship can be expressed as
$$Δ {\tilde{V}}^{f} = {\tilde{V}}_{V}^{f} - {\tilde{V}}_{R}^{f} = ( \frac{( 1 - α ) {B}_{V}^{org} + α {C}_{V}^{org}}{{B}_{V}^{f}} - \frac{{B}_{R}^{org}}{{B}_{R}^{f}} ) ( {V}^{org} - {V}_{0}^{org} )$$
where Δ\tilde{V}^{ƒ} is said difference between two model inversion estimates of volume concentration of fluids in the source rock, V^{org} is volume concentration of organic matter in the source rock, V₀^{org} is an initial guess for V^{org} used to start the model inversions, α is a partitioning parameter specifying organic matter distribution between the solid background and the inclusion space, coefficient C_{V}^{org} depends on the properties of the source rock's organic matter and other solid minerals that construct the solid background, coefficients B_{V}^{org} and B_{R}^{org} depend on the properties of the source rock's solid background, the source rock's organic matter, and microstructure of the source rock's inclusion space, and coefficients B_{V}^{ƒ} and B_{R}^{ƒ} depend on the properties of the source rock's solid background, the source rock's fluid, and microstructure of the source rock's inclusion space.

22. The method of claim 16, wherein the calibration of the rock physics model comprises calculation of log responses, comparison with log measurements, and iterative updates of input parameters of the model.

23. The method of claim 22, wherein the calculated log responses comprise one or more of P- and S-wave sonic logs, density, resistivity, velocity anisotropy, and resistivity anisotropy logs.

24. The method of claim 16, wherein the two model inversions comprise calculation of the log responses using the calibrated rock physics model, comparison with corresponding log measurements, and iterative updates of fluid volume concentration of the source rock.

25. A computer-implemented method for predicting physical properties of a source rock formation, comprising:
constructing an inclusion-based mathematical rock physics model that treats organic matter as solid inclusions, solid background, or both, and as a resistive phase of the source rock, and relates anisotropic elastic and electrical properties of source rock to in-situ rock and fluid properties; and
using the rock physics model either in a forward modeling sense to calculate effective anisotropic elastic and electrical properties of the source rock formation, or by inversion of sonic and resistivity logs to calculate total organic carbon in terms of a difference between elastic and electrical properties of the source rock.

26. A computer-implemented method for predicting anisotropic electrical properties of a source rock formation comprising:
constructing an inclusion-based mathematical rock physics model that treats organic matter as a resistive phase of the source rock, and relates anisotropic electrical properties of the source rock to in-situ rock and fluid properties; and
using the rock physics model to calculate effective electrical properties of the source rock formation.
